(19) United States
(12) Patent Application Publication
(10) Pub. No.: US 2017/0255897 A1
(43) Pub. Date: Sep. 7, 2017

(54) Cargo Delivery Apparatus

(71) Applicant: Wal-Mart Stores, Inc., Bentonville, AR (US)

(72) Inventor: Donald R. High, Noel, MO (US)

(21) Appl. No.: 15/446,579

(22) Filed: Mar. 1, 2017

Related U.S. Application Data
(60) Provisional application No. 62/302,066, filed on Mar. 1, 2016.

(51) Int. Cl. G06Q 10/08

(52) U.S. Cl. CPC G06Q 10/083

(57) ABSTRACT

A control circuit dynamically identifies ad hoc shuttle points. By one approach the control circuit identifies ad hoc shuttle points as a function of available cargo delivery vehicles and en route cargo (including items to be delivered to a specific recipient address). The control circuit then automatically assigns at least two of the available cargo delivery vehicles to meet at a particular ad hoc shuttle point in order to move at least one of the items from a first one of the available cargo delivery vehicles to a second one of the cargo delivery vehicles to thereby effect delivery of the item to the corresponding specific recipient address.

### CROSS-REFERENCE TO RELATED APPLICATION

This application claims the benefit of U.S. Provisional Application No. 62/302,066, filed Mar. 1, 2016, which is incorporated herein by reference in its entirety.

### TECHNICAL FIELD

These teachings relate generally to the vehicular delivery of cargo.

### BACKGROUND

The retail sale of various goods remains a large and important part of any modern economy, both for consumer-based purchases as well as business purchases. Accordingly, holding down costs is of paramount importance. Storage of unsold items represents one important cost point. In particular, warehouses, distribution centers, and storerooms all require a myriad of related expenses. Notwithstanding that such facilities as a modern distribution center are well designed and efficiently operated, those facilities nevertheless require costly space, utilities, personnel, and so forth.

So-called just-in-time manufacturing attempts to at least minimize some front end storage requirements at a manufacturing facility. Those techniques, however, are not well suited in most cases to the conveyance of retail goods.

### BRIEF DESCRIPTION OF THE DRAWINGS

The above needs are at least partially met through provision of the cargo delivery apparatus described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a schematic representation as configured in accordance with various embodiments of these teachings;

FIG. 4 comprises a schematic representation as configured in accordance with various embodiments of these teachings; and

FIG. 5 comprises a schematic representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a control circuit dynamically identifies ad hoc shuttle points. By one approach the control circuit identifies ad hoc shuttle points as a function of available cargo delivery vehicles and en route cargo (including items to be delivered to a specific recipient address). The control circuit then automatically assigns at least two of the available cargo delivery vehicles to meet at a particular ad hoc shuttle point in order to move at least one of the items from a first one of the available cargo delivery vehicles to a second one of the cargo delivery vehicles to thereby effect delivery of the item to the corresponding specific recipient address.

These teachings are highly flexible in practice and will accommodate a variety of embellishments and modifications. As one example in these regards, the aforementioned ad hoc shuttle points can include public parking lots, private parking lots, empty lots, roadside service facilities, vehicle-waiting facilities, and so forth. In other words, these ad hoc shuttle points need not be formal or specifically designed to serve as a cargo loading/unloading facility and in fact may ordinarily have a completely different usual purpose.

By one approach these teachings will accommodate using a head-worn user interface to locate an item within a cargo delivery vehicle that is to be moved to a different delivery vehicle at such an ad hoc shuttle point. Such a head-worn user interface may employ enhanced reality and/or a location-determination component to help the associate wearing the device to locate the desired item within the cargo delivery vehicle to thereby facilitate removal of that item. By one approach, this head-worn user interface may also include a scanner that can read, for example, identifying content on or in the items/packages being carried by such vehicles.

By one approach the control circuit can also help facilitate removing items from larger shipping containers and/or aggregating an item with other items into shipping containers at such ad hoc shuttle points. Using this approach a delivery container for a particular recipient can be effectively packed with different items at one or more ad hoc shuttle points.

So configured, these teachings permit in transit items to make their way to a purchaser without stopping at or experiencing any handling at an intermediary warehouse, storage facility, distribution center, or the like. Used aggressively in a supply chain, these teachings can facilitate greatly reducing reliance upon such facilities and hence can help reduce the cost of providing purchased items to their respective purchasers. In some cases these teachings can also help to shorten the time between taking a customer's order and delivering their ordered item(s).

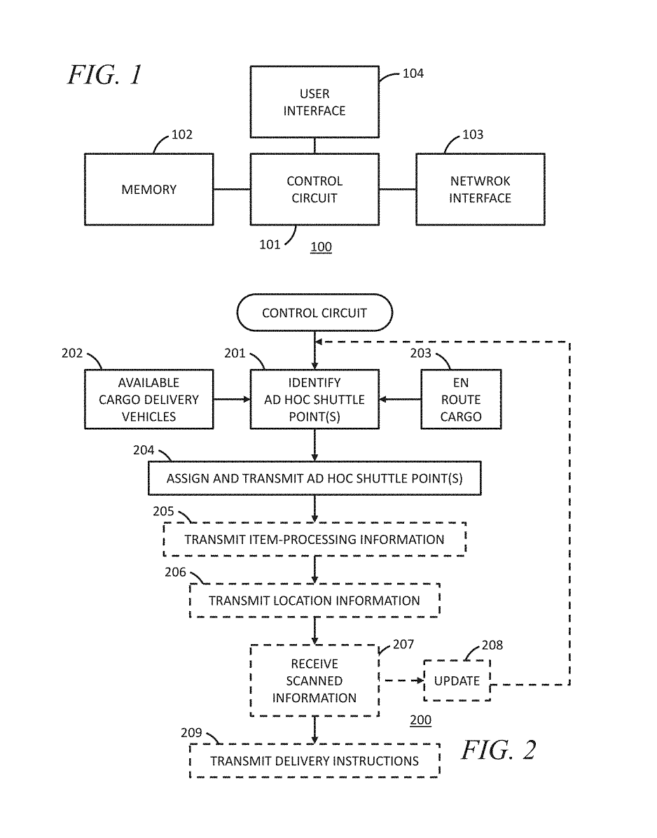

These and other benefits may become clearer upon making a thorough review and study of the following detailed description. Referring now to the drawings, FIG. 1 presents a portion of an illustrative apparatus 100 that accords with these teachings.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to other information that can be pertinent to carrying out the various activities described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this illustrative example the control circuit 101 also operably couples to a network interface 103. So configured the control circuit 101 can communicate with other elements (both within the apparatus 100 and external thereto) via the network interface 103. Network interfaces, including both wireless and non-wireless platforms, are well understood in the art and require no particular elaboration here.

Also if desired, the control circuit 101 can operably couple to a user interface 104. This user interface 104 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

Referring now to FIG. 2, an illustrative process 200 that is compatible with many of these teachings will be presented. For the sake of an illustrative example it will be presumed here that the aforementioned control circuit 101 carries out at least many of (and in some cases all of) the actions, steps, and/or functions of this process 200.

At block 201 the control circuit 101 dynamically identifies ad hoc shuttle points. As used herein, the word “dynamically” shall be understood to mean in an active and ongoing manner. “Ongoing” does not mean that the activity must be temporally seamless, uninterrupted, and continuous, but rather that the activity is readily undertaken in a responsive manner at times of need. As will be described in more detail below, these shuttle points are geographic locations where two or more cargo delivery vehicles can rendezvous and transfer or exchange cargo items.

Being “ad hoc,” these dynamically identified shuttle points are for a particular case at hand and without consideration of wider application. Accordingly, these ad hoc shuttle points need not be a physical location (such as a loading dock, a yard ramp, warehouse, or distribution center) that is designed or intended for ordinary use as a location where two or more cargo delivery trucks can transfer or exchange cargo items. Instead, these teachings will readily accommodate using, for example, a public parking lot, a private parking lot (such as a parking lot for a retail shopping facility), an empty lot, a roadside service facility (such as a restaurant area, fueling station, and so forth), a vehicle-weighing facility, and so forth as an ad hoc shuttle point.

The control circuit 101 can make use of various data points when dynamically identifying one or more ad hoc shuttle points. As one significant example in these regards, the control circuit 101 can dynamically identify ad hoc shuttle points as a function of available cargo delivery vehicles 202 that include, for example, at least one cargo delivery vehicle of particular interest (such as a cargo delivery vehicle carrying a particular cargo item of interest) or even a fleet of cargo delivery vehicles of particular interest. These cargo delivery vehicles can include all manner of trucks (including but not limited to very light trucks, light trucks, trucks, and heavy trucks), vans, automobiles, and motorcycles and powered scooters as well as human-powered vehicles such as bicycles. These teachings will also accommodate cargo delivery vehicles that are human piloted as well as partially or fully-autonomous vehicles.

By one approach, all of the available cargo delivery vehicles 202 are owned and/or operated on behalf of a same enterprise. By another approach, at least one of the available cargo delivery vehicles 202 is operated on behalf of a first enterprise while at least a second one of the available cargo delivery 202 is operated on behalf of a second enterprise that is different from the first enterprise.

As another significant example in these regards, the control circuit 101 can dynamically identify ad hoc shuttle points as a further function of en route cargo 203. This en route cargo 203 can include items that are to be delivered to specific recipient addresses as well as items that are presently without any particular specific destination. These items may be individually packaged or may be in a larger container with a plurality of similar items.

By one approach, the packaging for at least some of these items may comprise electronic tamper-proof packaging. Examples in these regards include a radio-frequency identification (RFID) tag having an operating state (that controls, for example, whether the RFID tag will respond to the interrogation signal of an RFID-tag reader) that depends upon the packaging integrity of the item (for example, whether the container has been opened or not). As another example in these regards the electronic tamper-proof packaging may include a machine-readable magnetic ink seal. Various approaches to electronic tamper-proof packaging are known in the art. As the present teachings are not especially sensitive to any particular choices in these regards, further description in these regards is not provided here for the sake of brevity.

The control circuit 101 identifies these ad hoc shuttle points in order to facilitate, ultimately, delivering one or more items to a specific recipient address while minimizing a need to store that one or more items at an intermediary building or other storage location such as a warehouse, distribution center, or storeroom. (The specific recipient address referred to herein can be any address to which physical items can be delivered and may include, for example, an address for a retail shopping facility or some other suitable customer address such as a residential address or a business address.)

The control circuit 101 therefore takes into account available en route cargo 203 that can serve as a source of one or more of the items to be delivered to the specific recipient address and the available cargo delivery vehicles 202 that may be carrying an already-specified item for that specific recipient address, that may be carrying an item that can now be designated for that specific recipient address, that may be used to carry such an item to another vehicle/ad hoc shuttle point, and/or that may be used to carry such an item or items directly to the specific recipient address.

Being a dynamic process 200, such considerations can be taken into account on a substantially regular basis (either on a regular periodic basis or sporadically as desired). Accordingly, these teachings will accommodate identifying and then re-identifying ad hoc shuttle points in support of facilitating the delivery of one or more items to a specific recipient address as circumstances may change. For example, 30 minutes after identifying a particular ad hoc shuttle point to be used as described herein, the underlying factual considerations may have changed in a particularly relevant manner. For example, a new-to-this-scenario cargo delivery vehicle may have just left a manufacturing source carrying an item of interest and may happen to be geographically close to another vehicle that is generally and conveniently heading in the direction of the specific recipient address. The control circuit 101 may respond to these new circumstances by identifying a new ad hoc shuttle point at which these two vehicles may rendezvous and transfer the item of interest from the one cargo delivery vehicle to the other.

These teachings are highly flexible in practice and will accommodate various extensions and modifications. As one example in these regards, the control circuit 101 may be configured to automatically assign at least three of the available cargo delivery vehicles 202 to meet at a particular ad hoc shuttle point in order to move at least one item from a first one of the available cargo delivery vehicles 202 and a second item from a second one of the available cargo delivery vehicles 202 to a third one of the available cargo delivery vehicles 202 to thereby facilitate and effect delivery of both the first and second item to a corresponding specific recipient address via that third one of the available cargo delivery vehicles 202.

It should be noted that the control circuit 101 may identify a plurality of ad hoc shuttle points (including a plurality of sequentially related ad hoc shuttle points) when identifying one such ad hoc shuttle point. Identifying a related plurality of such points can be useful, for example, when the assignment of a first one of ad hoc shuttle points makes sense and works well when presuming that one or more specific follow-on ad hoc shuttle points can further facilitate moving the one or more items to the ultimate delivery destination.

At block 204, having identified the aforementioned ad hoc shuttle point or shuttle points the control circuit 101 automatically assigns at least two of the available cargo delivery vehicles 202 to meet at a particular one of the ad hoc shuttle points in order to move at least one of the items from a first one of the available cargo delivery vehicles 202 to a second one of the available cargo delivery vehicles 202 to thereby further facilitate delivery of that item to a corresponding specific recipient address. The control circuit 101 also transmits this assignment to at least the respective cargo delivery vehicles 202.

By one approach both the first and the second one of the available cargo delivery vehicles 202 in the example above have a similar cargo-carrying capacity. By another approach, the second one of the available delivery vehicles 202 has a smaller cargo-carrying capacity than the first one of the available cargo delivery vehicles 202 (or vice versa).

When the control circuit 101 has previously identified a plurality of ad hoc shuttle points that pertain either to this particular item or to this particular specific recipient address, the control circuit 101 may transmit information regarding those additional ad hoc shuttle points at the same time as transmitting this first ad hoc shuttle point as just described or the control circuit 101 may abstain from transmitting that information at this time. For example, the control circuit 101 may transmit an assignment instructing the second cargo delivery vehicle 202 to subsequently meet a third one of the available cargo delivery vehicles 202 in order to move another item from the third cargo delivery vehicle 202 and the second delivery vehicle 202 where this additional item is also to be delivered to the specific recipient address to thereby facilitate delivery of both of these items to that specific recipient address.

In the example above the control circuit identifies ad hoc shuttle points and assigns and transmits information regarding the identified ad hoc shuttle point or points to two or more of the available cargo delivery vehicles 202 to facilitate having those respective cargo delivery vehicles 202 meet and transfer one or more specific items to ultimately facilitate a delivery to a specific recipient address. This process 200 will accommodate transmitting other information as well, however, if desired.

As one example, and as illustrated at optional block 205, the control circuit 101 can also transmit item-processing information. For example, the control circuit 101 can transmit an instruction that one or more items be removed from a larger shipping container (such as a shipping box containing or a palletized plurality of items comprising, for example, a bulk quantity of such items) before being moved to the second one of the available cargo delivery vehicles (i.e., the cargo delivery vehicle assigned to receive the item at the ad hoc shuttle point).

As another example, the control circuit 101 can transmit an instruction that at least one item be placed into a larger shipping container with at least one other designated item that is also to be delivered to the specific recipient address. By one approach this larger shipping container is a shipping container that is itself to be delivered to the specific recipient address.

Per other examples in these same regards, the control circuit 101 may also transmit information regarding item or container labeling (such as warnings regarding fragility, temperature sensitivity, correct or incorrect container orientation, signature requirements, and so forth), container handling requirements (such as a recommended or required use of a powered or unpowered dolly or pallet mover or restrictions regarding stacking), and so forth as desired.

As illustrated at optional block 206, the control circuit 101 can also transmit location information to, for example, relevant ones of the available cargo delivery vehicles 202 and/or to an intended delivery recipient. As one example in these regards, the various cargo delivery vehicles 202 may transmit their own location (automatically derived, for example, by an appropriate on-board global positioning system (GPS) receiver) to the control circuit 101 and the latter may then re-transmit at least some of that location information to others of the cargo delivery vehicles 202 to help facilitate scheduling and corresponding overall awareness.

As illustrated at optional block 207, in some cases there may be scanning equipment available at an ad hoc shuttle point (more detailed examples in these regards are provided further herein). Such scanning equipment can be used, for example, to scan information on an item (such as optically-encoded information or information contained in a radio-frequency identification (RFID) tag) when transferring that item from one cargo delivery vehicle to another. Upon receiving that scanned information, the control circuit 101 can update its own data records (at block 208) and then utilize and leverage that updated information to facilitate, for example, the identification and assignment of subsequent ad hoc shuttle points or to confirm the validity of or change previously-made assignments in these same regards.

As illustrated at optional block 209, these teachings will also accommodate having the control circuit 101 transmit specific delivery instructions to, for example, a driver or other person associated with the final cargo delivery vehicle 202 that will be employed to physically deliver one or more items to the specific delivery address. Such a transmission can occur separately from any of the foregoing transmissions or may be combined therewith as desired.

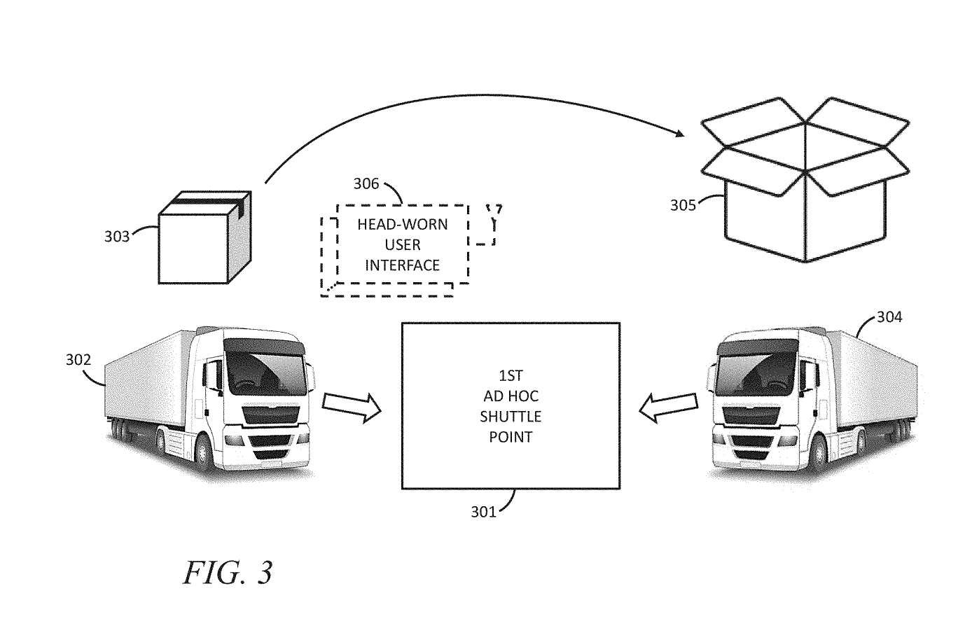

FIGS. 3 through 5 provides an illustrative example in these regards. It shall be understood that no particular limitations are intended by way of the specificity of the details of this example.

Beginning with FIG. 3, in this example the control circuit 101 assigns a first truck 302 carrying a first item 303 to rendezvous at a first ad hoc shuttle point 301 with a second truck 304. This assignment not only identifies the geographic location of the first ad hoc shuttle point 301 but also a rendezvous time. That rendezvous time can be a particular specified time or can be a time window that spans, for example, some predetermined period of time such as 15 minutes or 30 minutes. The identification of the first ad hoc shuttle point 301 can be somewhat general in nature (for example, a street address or an Interstate rest stop at a particular mile marker) or can be relatively specific (for example, a particular latitude and longitude coordinate or some specification regarding a particular location at a given street address such as “northwest corner of [street address],” “west side parking lot of mall,” and so forth.

Per the instructions of the control circuit 101, the item 303 being carried by the first truck 302 is transferred to a larger container, in this case, a large cardboard carton 305. By one approach those instructions specify a particular cardboard carton (for example, by one or more relevant dimensions or some other identifier or identifying feature). The instructions provided by the control circuit 101 may, if desired, also specify that the large cardboard carton 305 be sealed after receiving the first item 303 or the instructions may specify the opposite (i.e., that the large cardboard carton 305 be left unsealed). That cardboard carton 305 may be sourced by the first truck 302 or by the second truck 304 as desired or as assigned by the control circuit 101.

These teachings will accommodate optionally using a head-worn user interface 306 if desired. This head-worn user interface 306 can serve, for example, to help a driver or other person to locate the item 303 within the first truck 302. This head-worn user interface 306 may use enhanced reality (via a heads-up display) to indicate the location of the item within that vehicle. Such a device may include a location-determination component such as a global positioning system (GPS) component that can be used to properly overlay relevant enhanced reality visual content upon a real-time view of the interior and/or exterior of the truck by the person wearing the head-worn interface 306.

The aforementioned head-worn user interface 306 can also serve (in conjunction with the aforementioned control circuit 101) to dynamically switch correlation of the item 303 from a head-worn user interface 306 being worn by a person associated with the first truck 302 to the head worn user interface 306 being worn by a person associated with the second truck 304. By one approach this switch may be based upon one or more inputs from the persons involved.

As mentioned above the first item 303 may have a scannable label or other feature. Examples include both one and two-dimensional barcode as are known in the art, RFID tags, and so forth. The information in these scannable items may, for example, identify the item either generally or specifically, specify the customer's receiving address, or otherwise provide any other data of interest. In such a case, and if desired, the aforementioned head-worn user interface 306 may include a scanner that can compatibly scan the item 303 (and, in particular, the scannable label or other feature that is associated with that item 303). Such a scanning capability also be used, if desired, to switch correlation of the item 303 from the person associated with the first truck 302 to the person associated with a second truck 304.

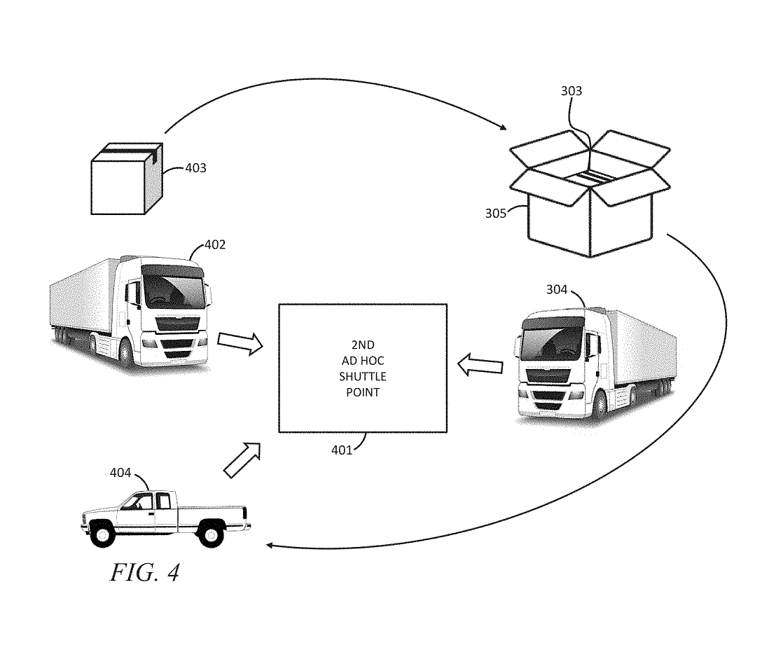

At a later time, and referring now to FIG. 4, the control circuit 101 assigns the second truck 304 to rendezvous at a (different) ad hoc shuttle point 401 with both a third truck 402 and a fourth truck 404. Pursuant to the instructions from the control circuit 101, a second item 403 is transferred from the third truck 402 to the large cardboard box 305. That large cardboard box 305 is then closed and sealed with the first and second items 303 and 403 contained therein. The large cardboard box 305 is then transferred to the fourth truck 404 which comprises a smaller vehicle (such as a pickup truck or van) well suited to ply residential streets.

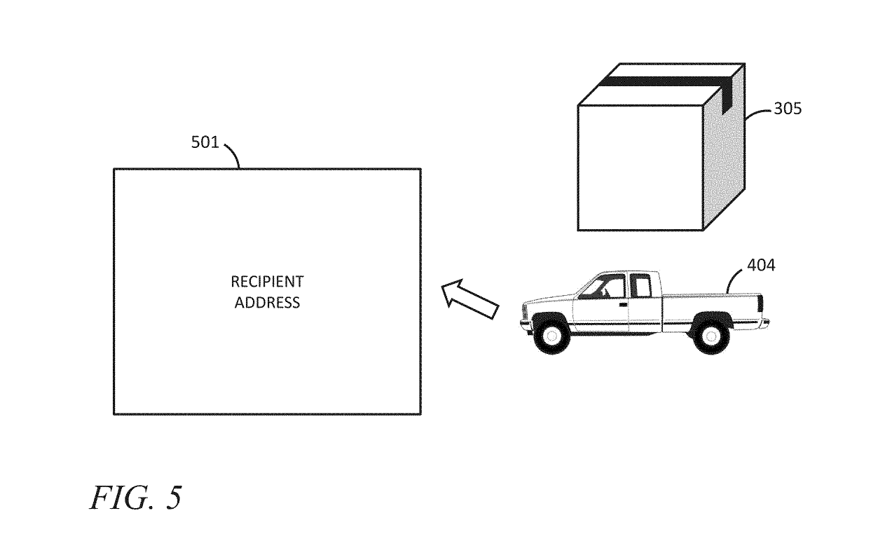

Referring now to FIG. 5, this example concludes when the fourth truck 404 drives to the appropriate recipient address 501 and physically delivers the large cardboard box 305 (containing the first and second items 303 and 403) to that recipient address 501 in accordance with whatever specific delivery instructions may apply (for example, obtaining a confirmation-of-delivery signature when required).

These teachings permit ordered items to make their way from a manufacturing source or a port of entry to a customer's delivery address without necessarily requiring unloading, temporary storage, and reloading at a permanent, dedicated facility such as a distribution center or warehouse. Amongst other possible benefits these teachings may often permit such an item to travel from source to customer in a more direct manner since diversions from a more direct route in order to visit a permanent, dedicated facility are avoided.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
at least one cargo delivery vehicle;
a control circuit configured to:
dynamically identify ad hoc shuttle points as a function of:
available cargo delivery vehicles that include the at least one cargo delivery vehicle; and
en route cargo including items to be delivered to specific recipient addresses; and
automatically assign at least two of the available cargo delivery vehicles to meet at a particular one of the ad hoc shuttle points in order to move at least one of the items from a first one of the available cargo delivery vehicles to a second one of the available cargo delivery vehicles to thereby effect delivery of the item to the corresponding specific recipient address.

2. The apparatus of claim 1 wherein the at least one cargo delivery vehicle comprises a fleet of cargo delivery vehicles.

3. The apparatus of claim 1 wherein the ad hoc shuttle points include at least one of:
a public parking lot;
a private parking lot;
an empty lot;
a roadside service facility;
a vehicle-weighing facility.

4. The apparatus of claim 1 wherein the control circuit is further configured to instruct that the at least one of the items be removed from a larger shipping container before being moved to the second one of the available cargo delivery vehicles.

5. The apparatus of claim 4 wherein the larger shipping container comprises a palletized plurality of items.

6. The apparatus of claim 4 wherein the larger shipping container comprises a shipping box.

7. The apparatus of claim 1 wherein the control circuit is further configured to instruct that the at least one of the items be placed in a larger shipping container with at least one other item that is also to be delivered to the specific recipient address.

8. The apparatus of claim 1 wherein the control circuit is further configured to:
automatically assign the second available cargo delivery vehicle to meet a third one of the available cargo delivery vehicles at a second particular one of the ad hoc shuttle points in order to move the at least one of the items from the second available cargo delivery vehicles to the third one of the available cargo delivery vehicles to thereby further effect delivery of the item to the corresponding specific recipient address.

9. The apparatus of claim 1 wherein the control circuit is further configured to:
automatically assign the second available cargo delivery vehicle to meet a third one of the available cargo delivery vehicles at a second particular one of the ad hoc shuttle points in order to move another item from the third available cargo delivery vehicle to the second available delivery vehicle, wherein the another item is also to be delivered to the specific recipient address to thereby effect delivery of both the item and the another item to the corresponding specific recipient address.

10. The apparatus of claim 9 wherein the control circuit is further configured to instruct that both the item and the another item be placed in a larger shipping container that is to be delivered to the specific recipient address.

11. The apparatus of claim 1 wherein the second one of the available cargo delivery vehicles has a smaller cargo-carrying capacity than the first one of the available cargo delivery vehicles.

12. The apparatus of claim 1 wherein the control circuit is further configured to instruct the second one of the available cargo delivery vehicles to complete a final delivery of the item to the specific recipient address.

13. The apparatus of claim 1 wherein the control circuit is further configured to: automatically assign at least three of the available cargo delivery vehicles to meet at the particular one of the ad hoc shuttle points in order to move at least one of the items from a first one of the available cargo delivery vehicles and a second one of the items from a second one of the available cargo delivery vehicles to a third one of the available cargo delivery vehicles thereby effect delivery of both the first and second item to the corresponding specific recipient address via the third one of the available cargo delivery vehicles.

14. The apparatus of claim 13 wherein the control circuit is further configured to instruct that the first and second items be placed in a shared larger shipping container that is to be delivered to the specific recipient address.

15. The apparatus of claim 1 wherein the specific recipient address comprises an address for a retail shopping facility.

16. The apparatus of claim 1 wherein the specific recipient address comprises a customer address.

17. The apparatus of claim 16 wherein the customer address comprises at least one of:
a residential address;
a business address.

18. The apparatus of claim 1 wherein the first one of the available cargo delivery vehicles is operated on behalf of a first enterprise and the second one of the available cargo delivery vehicles is operated on behalf of a second enterprise that is different from the first enterprise.
